(19) United States
(12) Patent Application Publication
(10) Pub. No.: US 2025/0033434 A1
(43) Pub. Date: Jan. 30, 2025

(54) THERMAL MANAGEMENT CIRCUIT

(71) Applicant: TOYOTA JIDOSHA KABUSHIKI KAISHA, Aichi-ken (JP)

(72) Inventors: Shoichi AKIYAMA, Toyota-shi (JP); Sohichi IMAI, Toyota-shi (JP)

(21) Appl. No.: 18/671,999

(22) Filed: May 23, 2024

(30) Foreign Application Priority Data
Jul. 28, 2023 (JP) 2023-123193

(51) Int. Cl. B60H 1/00

(52) U.S. Cl. CPC B60H 1/00885; B60H 1/00278

(57) ABSTRACT

The thermal management circuit includes a battery, a first flow path through which a heat medium in which heat exchange is performed between the battery and the battery flows, a water pump (first flow rate adjusting unit), and a water pump (second flow rate adjusting unit). In the thermal management circuit, the flow rate of the heat medium is adjusted by each of the water pump and the water pump, whereby the flow state and the stop state are switched. In the above stop state, the flow of the heat medium toward one side in the first flow path and the flow of the heat medium toward the other side in the first flow path are canceled, whereby the flow of the heat medium in the first flow path is stopped.

### CROSS-REFERENCE TO RELATED APPLICATION

This application claims priority to Japanese Patent Application No. 2023-123193 filed on Jul. 28, 2023, incorporated herein by reference in its entirety.

### BACKGROUND

### 1. Technical Field

The present disclosure relates to a thermal management circuit.

### 2. Description of Related Art

WO2022/208947 discloses switching of a flow path of a heat medium by a control valve in a circuit including a secondary battery. The circuit has a flow path through which a heat medium to exchange heat with the secondary battery flows. When the control valve is switched, the flow of the heat medium and the non-flow of the heat medium in the flow path are switched.

### SUMMARY

In WO2022/208947, as described above, it is necessary to perform control for switching the control valve in order to switch the flow of the heat medium to exchange heat with the secondary battery and the non-flow of the heat medium in the flow path through which the heat medium flows. Therefore, the control may become complicated.

The present disclosure has been made to solve the above issue, and an object of the present disclosure is to provide a thermal management circuit that can easily switch the flow of a heat medium to exchange heat with a battery and the non-flow of the heat medium in a flow path through which the heat medium flows.

A thermal management circuit according to one aspect of the present disclosure is a thermal management circuit through which a heat medium flows. The thermal management circuit includes:
a battery;
a first flow path through which the heat medium to exchange heat with the battery flows;
a first flow rate adjusting unit configured to adjust a flow rate of the heat medium that flows in a first direction in the first flow path; and
a second flow rate adjusting unit configured to adjust a flow rate of the heat medium that flows in a second direction opposite to the first direction in the first flow path.
   At least one of the first flow rate adjusting unit and the second flow rate adjusting unit is configured to adjust the flow rate of the heat medium to switch:
(i) a flowing state in which the heat medium flows through the first flow path; and
(ii) a stopped state in which a flow of the heat medium in the first flow path is stopped by canceling out a flow of the heat medium in the first direction in the first flow path and a flow of the heat medium in the second direction in the first flow path.

In the thermal management circuit according to the one aspect of the present disclosure, as described above, at least one of the first flow rate adjusting unit and the second flow rate adjusting unit adjusts the flow rate of the heat medium to switch the flowing state and the stopped state (non-flowing state) in the first flow path. Thus, it is possible to control the flowing state of the heat medium in the first flow path by simply controlling at least one of the first flow rate adjusting unit and the second flow rate adjusting unit. As a result, it is possible to easily switch the flow of the heat medium and the non-flow of the heat medium in the first flow path.

The thermal management circuit according to the one aspect may further include:
a first heat source;
a second heat source;
a second flow path that is connected to one end of the first flow path and in which the heat medium exchanges heat with the first heat source; and
a third flow path that is connected to the other end of the first flow path and in which the heat medium exchanges heat with the second heat source.
The first heat source may be configured to raise a temperature of the heat medium by supplying heat to the heat medium.
The second heat source may be configured to cool the heat medium by being supplied with heat from the heat medium.
A temperature raising circuit in which a temperature of the battery is raised may be defined when the heat medium from the second flow path flows through the first flow path and a flow of the heat medium from the third flow path through the first flow path is restricted. A cooling circuit in which the battery is cooled may be defined when the heat medium from the third flow path flows through the first flow path and a flow of the heat medium from the second flow path through the first flow path is restricted.
A flow stop circuit in which the flow of the heat medium in the first flow path is stopped may be defined when the flow of the heat medium from the second flow path and the flow of the heat medium from the third flow path are canceled out in the first flow path. With this configuration, it is possible to switch the temperature raising and the cooling of the battery by the heat medium flowing through the first flow path in addition to the switching between the flow of the heat medium and the non-flow of the heat medium in the first flow path.

In this case, the second heat source may be a chiller device.
The thermal management circuit may further include: a refrigeration cycle connected to the chiller device and including a compressor; a first heat exchanger provided on a downstream side of a portion where the first heat source and the heat medium exchange heat in the second flow path;
a high temperature circuit that is connected to the first heat exchanger and in which an electric heater is disposed; and
a second heat exchanger configured to exchange heat with a heat medium in the refrigeration cycle and a heat medium in the high temperature circuit. With this configuration, heat generated by operating the refrigeration cycle (compressor) can be used for heating or the like in addition to the heat generated by the electric heater.

The thermal management circuit including the chiller device and the high temperature circuit may further include
a first radiator connected in parallel to each of the second flow path and the third flow path. The high temperature circuit may include a heater core and a second radiator.
When the temperature raising circuit is defined, waste heat of each of the first heat source and the battery may be used for heating through the heater core or dissipated to outside air through the second radiator.
When the cooling circuit is defined, the heat medium cooled by the first radiator may further be cooled by the chiller device. With this configuration, when the temperature raising circuit is defined, the waste heat of each of the first heat source and the battery can be processed easily. When the cooling circuit is defined, the heat medium can be cooled efficiently by the first radiator and the chiller device.

The thermal management circuit including the first heat source and the second heat source may further include
a first flow path switching valve provided on a downstream side of a first portion where the first heat source and the heat medium exchange heat in the second flow path, and configured to switch flow paths of the heat medium.
The thermal management circuit may further include a second flow path switching valve provided on an upstream side of a second portion where the second heat source and the heat medium exchange heat in the third flow path, and configured to switch the flow paths of the heat medium.
The thermal management circuit may further include a flow valve provided on a downstream side of the second portion of the third flow path, and configured to control the flow of the heat medium.
The thermal management circuit may further include a first connecting flow path connecting a first connecting portion and the second flow path switching valve. The first connecting portion is a portion of the first flow path between the first flow path switching valve and a third portion where the battery and the heat medium exchange heat.
The thermal management circuit may further include a second connecting flow path connecting a second connecting portion and the first flow path switching valve. The second connecting portion is a portion of the third flow path between the second portion and the second flow path switching valve.
The first flow path may connect the first flow path switching valve and a third connecting portion. The third connecting portion is a portion of the third flow path between the second portion and the flow valve. With this configuration, the flow direction of the heat medium in the first flow path can be switched easily by the first flow path switching valve, the second flow path switching valve, and the flow valve.

In the thermal management circuit according to the one aspect, when outputs of the first flow rate adjusting unit and the second flow rate adjusting unit are increased or reduced in a predetermined cycle, an interface between the heat media that are mutually cancelled out may reciprocate in a region corresponding to the battery in the first flow path. With this configuration, the temperatures of a plurality of cells of the battery can easily be equalized by the heat medium.

According to the present disclosure, it is possible to easily switch the flow of the heat medium to exchange heat with the battery and the non-flow of the heat medium in the flow path through which the heat medium flows.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a thermal management system according to an embodiment;

FIG. 2 is a first view illustrating a state in which the flow of the heat medium in the first flow path is stopped in the thermal management circuit according to the embodiment;

FIG. 3 is a second diagram of a state in which the flow of the heat medium in the first flow path is stopped in the thermal management circuit according to the embodiment;

FIG. 4 is a diagram of a state in which a battery and a unit circuit are cooled in a thermal management circuit according to an embodiment;

FIG. 5 is a diagram of a state in which a battery is equalized in a thermal management circuit according to an embodiment;

FIG. 6 shows the flow rate of the water pump in the condition of FIG. 5;

FIG. 7 is a diagram of a state in which cooling of a unit circuit and heat pump heating using heat by cooling of a battery are performed in a thermal management circuit according to an embodiment;

FIG. 8 is a first diagram of a state in which a temperature of a battery and a cooling of a unit circuit are performed in a thermal management circuit according to an embodiment;

FIG. 9 is a diagram illustrating a state in which the temperature of the high temperature circuit is increased before the temperature of the battery is increased in the thermal management circuit according to the embodiment;

FIG. 10 is a diagram illustrating a state in which the temperature of the high temperature circuit is increased while the temperature of the battery is increased in the thermal management circuit according to the embodiment;

FIG. 11 is a diagram of a thermal management circuit according to an embodiment in which cooling of a battery and heat pump heating using heat by cooling of a unit circuit are performed; and

FIG. 12 is a second diagram of a state in which the temperature of the battery and the cooling of the unit circuit are performed in the thermal management circuit according to the embodiment.

### DETAILED DESCRIPTION OF EMBODIMENTS

Hereinafter, a thermal management circuit according to the present disclosure will be described. The thermal management circuit is mounted, for example, on an electrified vehicle (not shown). Electrified vehicle on which the thermal management circuit is mounted is preferably vehicles on which a battery for driving is mounted, for example battery electric vehicle (BEV), hybrid electric vehicle (HEV), plug-in hybrid electric vehicle (PHEV), and fuel cell electric vehicle (FCEV). However, the use of the thermal management circuit according to the present disclosure is not limited to a vehicle.

### Overall Configuration

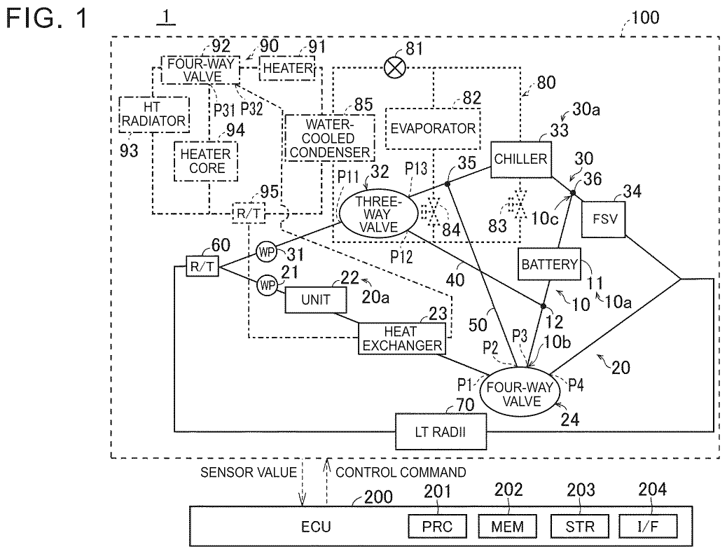

FIG. 1 is a diagram illustrating an example of an overall configuration of a thermal management system 1 according to an embodiment of the present disclosure. The thermal management system 1 includes a thermal management circuit 100 and an Electronic Control Unit (ECU) 200.

The thermal management circuit 100 includes a first flow path 10, a battery 11, a second flow path 20, a water pump (W/P) 21, unit circuit 22, heat exchanger 23, four-way valve 24, third flow path 30, water pump 31, three-way valve 32, chiller device 33, Flow Shut Valve (FSV) 34, first connecting flow path 40, second connecting flow path 50, reservoir tank (R/T) 60, Low Temperature (LT) radiator 70, refrigeration cycle 80, and high temperature circuit 90. The unit circuit 22 and the chiller device 33 are examples of the “first heat source” and the “second heat source” of the present disclosure, respectively. The water pump 21 and the water pump 31 are examples of the “first flow rate adjusting unit” and the “second flow rate adjusting unit” of the present disclosure, respectively. The four-way valve 24 and the three-way valve 32 are examples of the “first flow path switching valve” and the “second flow path switching valve” of the present disclosure, respectively. The heat exchanger 23 and FSV 34 are exemplary “first heat exchanger” and “flow valve” of the present disclosure, respectively. The low-temperature radiator 70 is an example of the “first radiator” of the present disclosure.

In the thermal management circuit 100, a wheatstone bridge circuit is formed by the first flow path 10, the second flow path 20, and the third flow path 30.

The heat medium flowing through the first flow path 10 is heat-exchanged with the battery 11. In other words, the first flow path 10 is provided with a partial 10a that is heat-exchanged with the battery 11. The first flow path 10 connects the second flow path 20 and the third flow path 30. In the following description, the circulation of the heat medium through the partial 10a may be described as the circulation of the heat medium through the battery 11. In addition, the partial 10a is an exemplary “third portion” and “an area corresponding to a battery” of the present disclosure.

Specifically, one end 10b of the first flow path 10 is connected to the second flow path 20 (the four-way valve 24). The other end 10c of the first flow path 10 is connected to the third flow path 30 (portion 36). The portion 36 is provided between the chiller device 33 and FSV 34. Note that the portion 36 is an example of a “third connecting portion” of the present disclosure.

The heat medium flowing through the second flow path 20 is heat-exchanged with the unit circuit 22. In other words, the second flow path 20 is provided with a partial 20a that is heat-exchanged with the unit circuit 22. The heat medium flowing through the second flow path 20 is heated by being supplied with heat from the unit circuit 22. The unit circuit 22 is provided with a Power Control Unit (PCU) (not shown), an oil cooler (O/C), a step-up/down converter, and the like. In the following description, the flow of the heat medium through the partial 20a may be referred to as the flow of the heat medium through the unit circuit 22. Note that the partial 20a is an exemplary “first portion” of the present disclosure.

The water pump 21 is provided in the second flow path 20. The water pump 21 adjusts the flow rate of the heat medium flowing through the second flow path 20. As a result, the flow rate of the heat medium from the second flow path 20 flowing (to flow) in the first flow path 10 is adjusted by the water pump 21.

The heat exchanger 23 is provided in the second flow path 20. The heat-exchanger 23 is provided downstream of the partial 20a (unit circuit 22). The heat exchanger 23 is a water heat exchanger. The heat exchanger 23 is connected to the high temperature circuit 90.

The high temperature circuit 90 is provided with an electric heater 91, a four-way valve 92, a high temperature (HT) radiator 93, a heater core 94, and a reservoir tank 95. The high temperature circuit 90 is connected to the water-cooled condenser 85. The heat medium of the high temperature circuit 90 flows through either the first path through the reservoir tank 95-water cooled condenser 85-electric heater 91-four-way valve 92-heater core 94-reservoir tank 95, the second path through the reservoir tank 95-water cooled condenser 85-electric heater 91-four-way valve 92-heat exchanger 23-reservoir tank 95, and the third path through the reservoir tank 95-water cooled condenser 85-electric heater 91-four-way valve 92-high temperature radiator 93. For example, a heat medium may flow through both the first path and the second path. The water-cooled condenser 85 and the high temperature radiator 93 are examples of the “second heat exchanger” and the “second radiator” of the present disclosure, respectively.

The four-way valve 92 has a port P31 connected to a flow path with the heater core 94 and a port P32 connected to a flow path with the heat exchanger 23.

The four-way valve 24 is provided in the second flow path 20. The four-way valve 24 is provided downstream of the partial 20a (unit circuit 22) and the heat-exchanger 23. In other words, the four-way valve 24 is provided on the side opposite to the water pump 21 with respect to the partial 20a (unit circuit 22) and the heat-exchanger 23. The four-way valve 24 is configured to be capable of switching the flow path of the heat medium. The four-way valve 24 is connected to each of the first flow path 10, the second flow path 20 (upstream side and downstream side), and the second connecting flow path 50.

The four-way valve 24 has a port P1 connected to a flow path with the heat exchanger 23, a port P2 connected to the second connecting flow path 50, a port P3 connected to the first flow path 10, and a port P4 connected to a flow path downstream of the four-way valve 24 in the second flow path 20.

The heat medium flowing through the third flow path 30 is heat-exchanged with the chiller device 33. In other words, the chiller device 33 is provided on the partial 30a of the third flow path 30. The heat medium flowing through the third flow path 30 is cooled by supplying heat to the chiller device 33. Note that the partial 30a is an exemplary “second portion” of the present disclosure.

The water pump 31 is provided in the third flow path 30. The water pump 31 is configured to be able to adjust the flow rate of the heat medium flowing through the third flow path 30. As a result, the flow rate of the heat medium from the third flow path 30 flowing in the first flow path 10 is adjusted by the water pump 31.

The three-way valve 32 is provided upstream of the partial 30a (chiller device 33) of the third flow path 30. The three-way valve 32 is provided between the partial 30a (chiller device 33) of the third flow path 30 and the water pump 31.

The three-way valve 32 has a port P11 connected to a flow path between the third flow path 30 and the water pump 31, a port P12 connected to the first connecting flow path 40, and a port P13 connected to a flow path between the third flow path 30 and the chiller device 33 (partial 30a).

FSV 34 is provided on a side of the third flow path 30 opposite to the three-way valve 32 with respect to the partial 30a (i.e., a downstream side of the partial 30a). FSV 34 is configured to be capable of switching between circulation and non-circulation of the heat medium.

In the third flow path 30, a connecting portion 35 is provided between the chiller device 33 (partial 30a) and the three-way valve 32. The second connecting flow path 50 connects the connecting portion 35 and the four-way valve 24. Note that the connecting portion 35 is an example of the “second connecting portion” of the present disclosure.

In the first flow path 10, a connecting portion 12 is provided between the battery 11 (partial 10a) and the four-way valve 24. The first connecting flow path 40 connects the connecting portion 12 and the three-way valve 32. Note that the connecting portion 12 is an example of the “first connecting portion” of the present disclosure.

The reservoir tank 60 is connected to each of the second flow path 20 and the third flow path 30 on the upstream side of the second flow path 20 and the third flow path 30. The reservoir tank 60 maintains the pressure and amount of the heat medium in the thermal management circuit 100 by storing a portion of the heat medium in the thermal management circuit 100 (the first flow path 10, the second flow path 20, and the third flow path 30).

The low-temperature radiator 70 is arranged so that the heat medium from at least one of the second flow path 20 and the third flow path 30 flows. In the low-temperature radiator 70, the heat medium is heat-exchanged with the outside air. The heat medium heat-exchanged with the outside air by the low-temperature radiator 70 flows to the reservoir tank 60.

The refrigeration cycle 80 is connected to the chiller device 33. The refrigeration cycle 80 is provided with a compressor 81, an evaporator 82, an expansion valve 83, and an expansion valve 84. The refrigeration cycle 80 is connected to a water-cooled condenser 85. The heat medium of the refrigeration cycle 80 and the heat medium of the high temperature circuit 90 are heat-exchanged in the water-cooled condenser 85.

The heat medium (gas-phase refrigerant or liquid-phase refrigerant) circulating in the refrigeration cycle 80 flows through one/both of the first path of the compressor 81-water-cooled condenser 85-expansion valve 84-evaporator 82-compressor 81 and the second path of the compressor 81-water-cooled condenser 85-expansion valve 83-chiller device 33-compressor 81.

ECU 200 controls the thermal management circuit 100. ECU 200 includes a processor 201, a memory 202, a storage 203, and an interface 204.

The processor 201 is, for example, Central Processing Unit (CPU) or Micro-Processing Unit (MPU). The memories 202 are, for example, Random Access Memory (RAM). The processor 201 reads a system program and a control program stored in the storage 203, expands the system program and the control program in the memory 202, and executes the system program, thereby realizing various processes. Interface 204 controls communication between ECU 200 and the components of thermal management circuit 100.

ECU 200 generates a control command based on sensor values and the like acquired from various sensors (not shown) included in the thermal management circuit 100, and outputs the generated control command to the thermal management circuit 100. The three-way valve 32, the four-way valve 24, the four-way valve 92, and FSV 34 are controlled based on the control command from ECU 200. In addition, the power of each of the electric heater 91, the water pump 21, and the water pump 31 is controlled based on a control command from ECU 200.

Here, in the conventional thermal management circuit, by switching the flow path of the heat medium by the switching valve, the flow and non-flow of the heat medium in the flow path corresponding to the first flow path 10 is switched. On the other hand, it is desired to more easily switch between circulation and non-circulation of the heat medium.

Therefore, in the present embodiment, when the flow of the heat medium in the first flow path 10 is controlled, the flow rates of the heat medium in each of the water pump 21 and the water pump 31 are adjusted. Thus, the circulation state in which the heat medium flows through the first flow path 10 and the stop state in which the flow of the heat medium in the first flow path 10 is stopped are switched. In the stopped state, the flow of the heat medium toward one side in the first flow path 10 (for example, from the portion 36 toward the four-way valve 24) and the flow of the heat medium toward the other side in the first flow path 10 (for example, from the four-way valve 24 toward the portion 36) are cancelled out. As a result, the circulation (water flow) of the heat medium in the first flow path 10 is stopped.

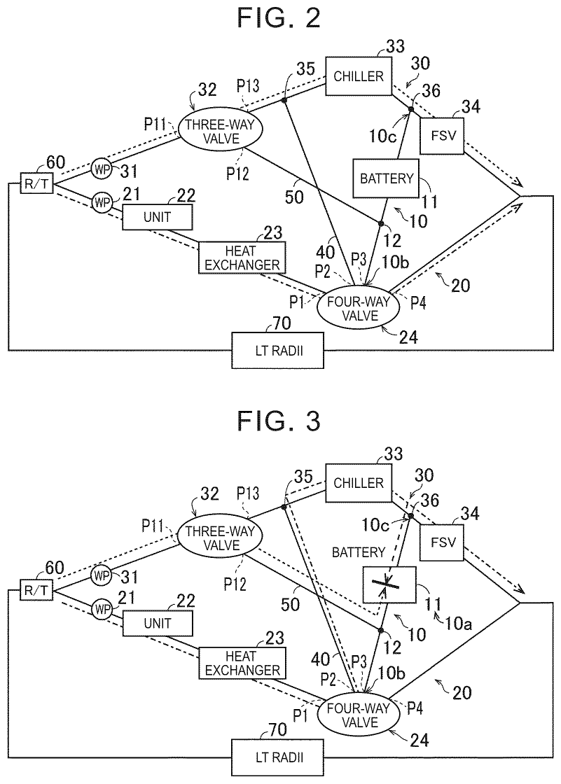

FIG. 2 shows an exemplary stopped condition in which the flow of the heat medium in the first flow path 10 is stopped. In this example, the outputs of the water pump 21 and the water pump 31 are adjusted so that the flow rate of the four-way valve 24 of the heat medium in the second flow path 20 is equal to the flow rate of the portion 36 of the heat medium in the third flow path 30. As a result, the flow of the heat medium from the four-way valve 24 side toward the battery 11 and the flow of the heat medium from the portion 36 side toward the battery 11 are cancelled out in the first flow path 10. As a result, the heat medium does not flow from each of the second flow path 20 and the third flow path 30 into the first flow path 10. FSV 34 is open.

In the embodiment shown in FIG. 2, in the three-way valve 32, only the port P12 connected to the second connecting flow path 50 is closed. In the four-way valve 24, only the port P2 connected to the first connecting flow path 40 is closed. As a result, the heat medium (see the dashed line) from the water pump 21 flows through the path of the unit circuit 22-the heat exchanger 23-the four-way valve 24-the low-temperature radiator 70-the reservoir tank 60. In addition, the heat medium (see broken lines) from the water pump 31 flows through the path of the three-way valve 32-chiller device 33-FSV34-low-temperature radiator 70-reservoir tank 60. In addition, the unit circuit 22 is cooled by the heat medium flowing through the second flow path 20.

FIG. 3 is an example in which the flow of the heat medium in the first flow path 10 is stopped. In this example, the outputs of the water pump 21 and the water pump 31 are adjusted so that the flow rate of the heat medium (the heat medium of the connecting portion 12) from the three-way valve 32 through the second connecting flow path 50 and the flow rate of the heat medium in the portion 36 of the third flow path 30 are equal to each other. As a result, the flow of the heat medium from the connecting portion 12 side toward the battery 11 and the flow of the heat medium from the portion 36 side toward the battery 11 are canceled out. Specifically, the heat medium from both sides pushes against each other in the partial 10a, whereby the flow of the heat medium is stopped.

In the embodiment shown in FIG. 3, in the three-way valve 32, only the port P13 is closed. In the four-way valve 24, only the port P3 and the port P4 are closed. FSV 34 is open. Thus, the heat medium from the water pump 21 flows through the path of the unit circuit 22-the heat exchanger 23-the four-way valve 24-the first connecting flow path 40-the chiller device 33-FSV34-low-temperature radiator 70-the reservoir tank 60, and the path of the unit circuit 22-the heat exchanger 23-the four-way valve 24-the first connecting flow path 40-the chiller device 33-the battery 11. The heat medium from the water pump 31 flows through the path of the three-way valve 32-the second connecting flow path 50-the battery 11. In addition, the unit circuit 22 is cooled by the heat medium flowing through the second flow path 20.

In the embodiment shown in FIG. 3, heat from the high temperature circuit 90 (see FIG. 1) is supplied to the heat medium in the second flow path 20 via the heat exchanger 23. The heat from the high temperature circuit 90 supplied to the heat medium in the second flow path 20 is supplied to the refrigeration cycle 80 via the chiller device 33. This increases the amount of pumping work of the compressor 81 due to an increase in the amount of heat medium gasified in the refrigeration cycle 80. As a result, the heat generated in the compressor 81 increases. The heat generated in the compressor 81 is supplied to the high temperature circuit 90 via the water-cooled condenser 85. As a result, the temperature of the heat medium of the high temperature circuit 90 rises. Increasing the temperature of the heat medium of the high temperature circuit 90 by circulating heat as described above is hereinafter referred to as “heat circulation”. During this thermal cycling, the port P32 of the four-way valve 92 of the high temperature circuit 90 is opened. When the heat medium of the high temperature circuit 90 is sufficiently warmed by the heat circulation, the heat circulation may be stopped by closing the expansion valve 83 connected to the chiller device 33.

In the embodiment shown in FIG. 3, the port P13 may be opened instead of the port P12 of the three-way valve 32. In this case, the flow of the heat medium is stopped by pressing the heat media between the three-way valve 32 and the connecting portion 35.

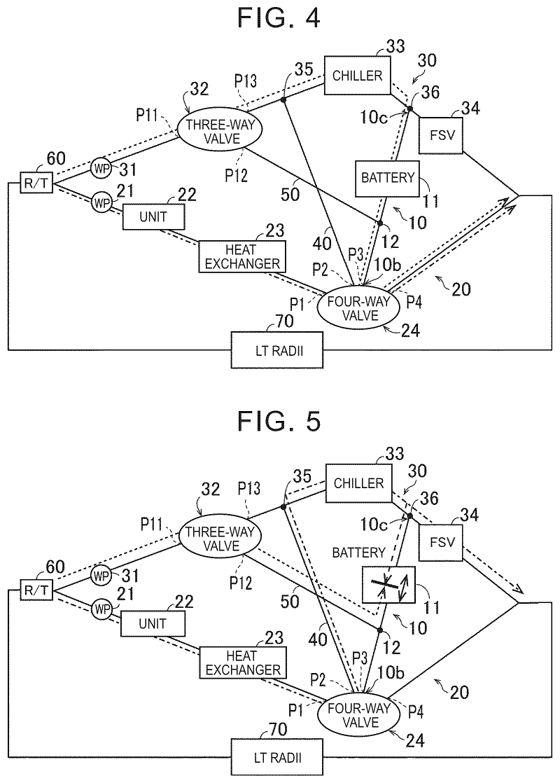

FIG. 4 is a diagram illustrating an example of a circulation condition in which a heat medium is circulated in the first flow path 10. In the three-way valve 32, only the port P12 is closed. FSV34 is closed. In the four-way valve 24, only the port P2 is closed. The heat medium from the water pump 21 flows through the path of the unit circuit 22-the heat exchanger 23-the four-way valve 24-the low-temperature radiator 70-the reservoir tank 60. In addition, the heat medium from the water pump 31 flows through the path of the three-way valve 32-chiller device 33-battery 11-four-way valve 24-low-temperature radiator 70-reservoir tank 60. That is, the heat medium cooled in the low-temperature radiator 70 is further cooled in the chiller device 33. In addition, the unit circuit 22 is cooled by the heat medium flowing through the second flow path 20.

In the embodiment shown in FIG. 4, the flow rate of the four-way valve 24 of the heat medium in the second flow path 20 is smaller than the flow rate of the portion 36 of the heat medium in the third flow path 30. As a result, in the first flow path 10, the heat media are not cancelled, and the heat media flows from the portion 36 toward the four-way valve 24. The battery 11 is cooled by the heat medium flowing through the first flow path 10.

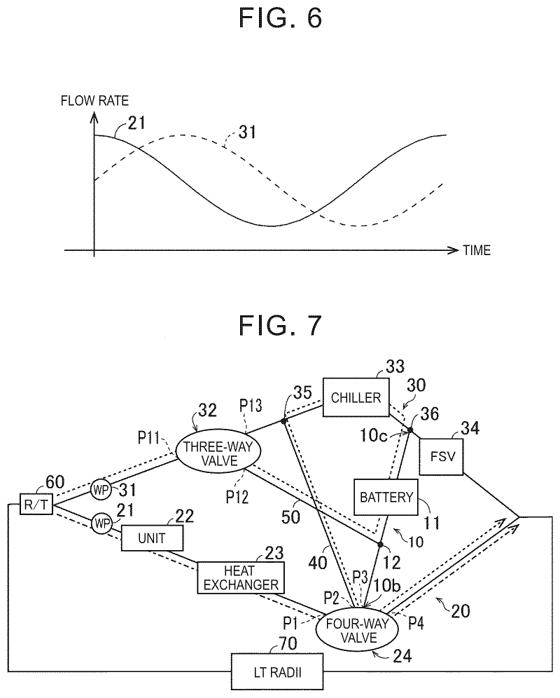

The example shown in FIG. 5 differs from the example shown in FIG. 3 in that the water pump 21 (31) is powered, while the example shown in FIG. 3 is the same. In the embodiment shown in FIG. 5, the wave shape indicating the output (flow rate) of the water pump 21 (31) changes to a sinusoidal shape (see FIG. 6) in synchronization with each other. Specifically, the peak of the waveform of the water pump 21 and the peak of the waveform of the water pump 31 are shifted from each other. As a result, the flow rate (the flow rate) of the heat medium that is pressed against each other in the partial 10a fluctuates over time. Consequently, the interface between the heating media is reciprocated in the partial 10a (in the direction in which the first flow path 10 extends). In the partial 11a, the flow direction from the partial 11a toward the portion 36, the stopped state, and the flow direction from the partial 11a toward the portion 12 are sequentially switched, and the heat medium swings in the partial 10a.

The battery 11 includes a plurality of cells, and the cells are arranged in a direction (arrangement direction) in which the first flow path 10 extends in the partial 11a. Here, when the flow direction of the heat medium is fixed, the temperature of the heat medium increases from the upstream side toward the downstream side in the flow direction. A cell located downstream in the flow direction exchanges heat with a heat medium having a relatively high temperature. As a result, the temperature of the cell located on the downstream side in the flow direction of the heat medium tends to be higher than the temperature of the cell located on the upstream side in the flow direction.

Therefore, as described above, in the partial 10a, the heating medium is mixed by swinging the flow direction of the heating medium, and the temperature of the heating medium is equalized in the partial 10a. By cooling each cell by the heat medium thus homogenized, it is possible to suppress the occurrence of temperature variation in the cell.

FIG. 7 is a diagram illustrating an example of a circulation condition in which a heat medium is circulated in the first flow path 10. In the three-way valve 32, only the port P13 is closed. In the four-way valve 24, only the port P3 is closed. FSV 34 is closed. The heat medium from the water pump 21 flows through the path of the unit circuit 22-the heat exchanger 23-the four-way valve 24-the low-temperature radiator 70-the reservoir tank 60. In addition, the heat medium from the water pump 31 flows through the path of the three-way valve 32, the second connecting flow path 50, the battery 11, the chiller device 33, the first connecting flow path 40, the four-way valve 24, the low-temperature radiator 70, and the reservoir tank 60. The unit circuit 22 is cooled by the heat medium flowing through the second flow path 20.

The battery 11 is cooled by the heat medium flowing through the first flow path 10. The heat medium deprived of heat from the battery 11 supplies heat to the refrigeration cycle 80 via the chiller device 33. Heat is supplied from the refrigeration cycle 80 to the high temperature circuit 90 via the water-cooled condenser 85. As a result, heat supplied to the high temperature circuit 90 is used, and warm air is sent from the heater core 94 to the cabin (not shown). That is, heat pump heating using waste heat of the battery 11 is performed. At this time, the port P31 of the four-way valve 92 of the high temperature circuit 90 is in the open state (see FIG. 1), and the port P32 is in the closed state. When the heat pump heating is not required, the waste heat is discharged to the outside air through the high temperature radiator 93 (see FIG. 1). This also applies to other circuits capable of the following heat pump heating.

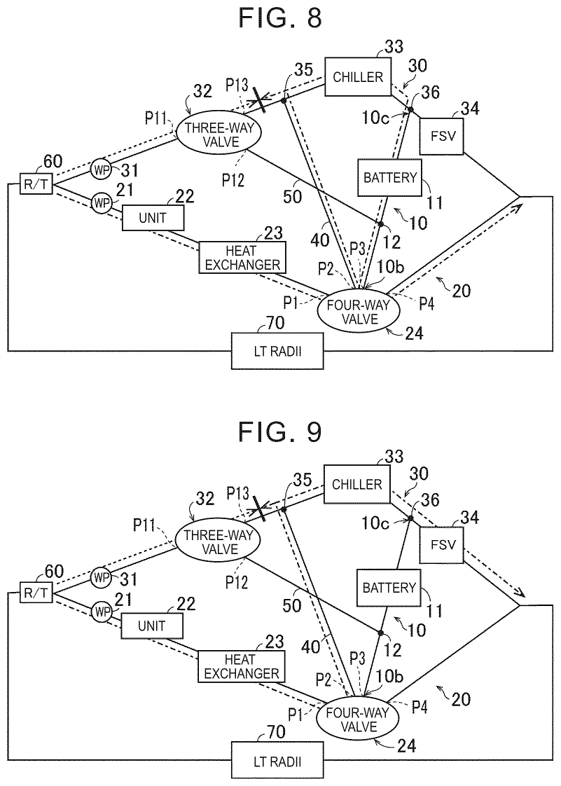

FIG. 8 shows an exemplary flow condition in which the heat medium flows in the first flow path 10. In the three-way valve 32, only the port P12 is closed. In the four-way valve 24, all the ports P1 to P4 are open. FSV34 is closed. The heat medium from the water pump 21 flows through the path of the unit circuit 22-the heat exchanger 23-the four-way valve 24-the battery 11-the chiller device 33-the first connecting flow path 40 (diverted to the three-way valve 32 side)-the four-way valve 24-the low-temperature radiator 70-the reservoir tank 60. Further, the heat medium from the water pump 31 tends to flow to the chiller device 33 side through the three-way valve 32. In this case, the heating media press together between the three-way valve 32 and the connecting portion 35. The unit circuit 22 is cooled by the heat medium flowing through the second flow path 20. The heat of the unit circuit 22 is supplied to the battery 11 by the heat medium flowing through the first flow path 10. As a result, the temperature of the battery 11 is increased.

In the example shown in FIG. 8, unlike the example of FIG. 7 in which the heat pump heating is performed using the waste heat of the unit circuit 22, the waste heat of the battery 11 (and the heat of the outside air) in addition to the unit circuit 22 can also be used for the heat pump heating. At this time, the port P32 of the four-way valve 92 of the high temperature circuit 90 (see FIG. 1) is closed.

FIG. 9 shows a circuit for raising the temperature of the heat medium of the high temperature circuit 90 (see FIG. 1) prior to raising the temperature of the battery 11. In the embodiment shown in FIG. 9, in the three-way valve 32, only the port P12 is closed. In the four-way valve 24, the port P3 and P4 are closed. FSV 34 is open. The heat medium from the water pump 21 flows through the unit circuit 22-the heat exchanger 23-the four-way valve 24-the first connecting flow path 40-the chiller device 33 (diverted toward the three-way valve 32)-FSV 34-low-temperature radiator 70-the reservoir tank 60. Further, the heat medium from the water pump 31 tends to flow to the chiller device 33 side through the three-way valve 32. In this case, the heating media press together between the three-way valve 32 and the connecting portion 35. The unit circuit 22 is cooled by the heat medium flowing through the second flow path 20.

Further, in the embodiment shown in FIG. 9, the port P32 of the four-way valve 92 of the high temperature circuit 90 (see FIG. 1) is opened. As a result, the above-described heat circulation is performed. As a result, the temperature of the heat medium of the high temperature circuit 90 rises. When the thermal management circuit 100 is switched so that the heat medium flows through the battery 11 after the heat medium of the high temperature circuit 90 is raised in advance, the temperature of the battery 11 is raised by the heat generated by the heat circulation. The port P31 of the four-way valve 92 may be open.

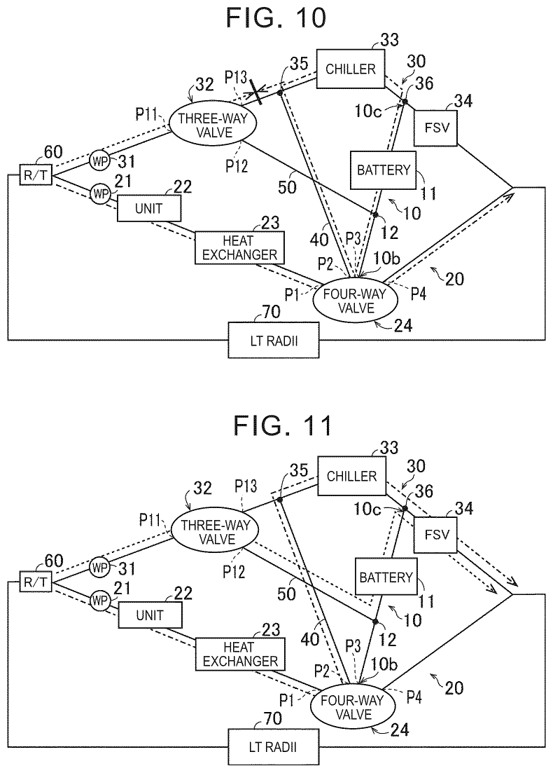

The example shown in FIG. 10 differs from the example shown in FIG. 9 in that the heat circulation is performed while the temperature of the battery 11 is raised by the heat medium. In the embodiment shown in FIG. 10, waste heat from the battery 11 can also be used for heat circulation. The port P31 of the four-way valve 92 may be open.

FIG. 11 is an example of a flow condition in which the heat medium flows in the first flow path 10. In the three-way valve 32, only the port P13 is closed. In the four-way valve 24, only the port P3 and P4 are closed. FSV 34 is open. The heat medium from the water pump 21 flows through the unit circuit 22-the heat exchanger 23-the four-way valve 24-the first connecting flow path 40-the chiller device 33-FSV 34-low-temperature radiator 70-the reservoir tank 60. The heat medium from the water pump 31 flows through the three-way valve 32-the second connecting flow path 50-the battery 11-FSV34-low-temperature radiator 70-the reservoir tank 60. The unit circuit 22 is cooled by the heat medium flowing through the second flow path 20. The battery 11 is cooled by the heat medium flowing through the first flow path 10. The waste heat (and the heat of the outside air) of the unit circuit 22 can be used for heat pump heating. At this time, the port P32 of the four-way valve 92 of the high temperature circuit 90 (see FIG. 1) is closed.

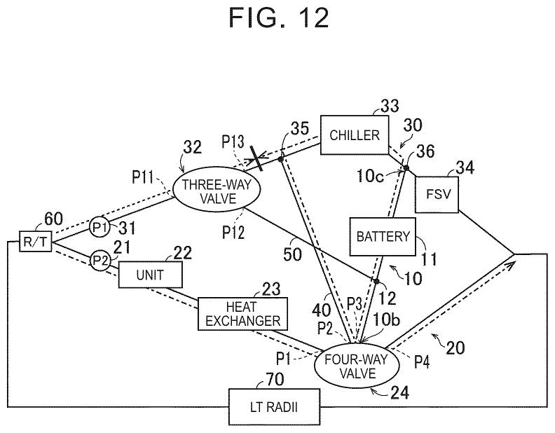

The example shown in FIG. 12 differs from the example shown in FIG. 8 in that the electric heaters 91 of the high temperature circuit 90 (see FIG. 1) are turned off. The circuit of FIG. 12 may be formed, for example, when only the temperature rise of the battery 11 is performed prior to the running of the vehicles without operating the heating. In addition, the circuit of FIG. 12 may be formed when the heat generation amount of the unit circuit 22 becomes relatively large during the traveling of the vehicle, so that the heating (and the temperature rise of the battery 11) can be performed using only the heat generation of the unit circuit 22.

In FIG. 3, FIGS. 8 to 10, and FIG. 12, the ports P11 to P13 of the three-way valve 32 may be closed to turn off the water pump 31.

Air bleeding for allowing the heat medium to flow through all the flow paths of the thermal management circuit 100 is performed by sequentially switching the opening and closing states of the ports in the switching valves (32 and 24).

As described above, in the present embodiment, the flow rate of the heat medium is adjusted by each of the water pump 21 and the water pump 31, so that the flow of the heat medium toward one side in the first flow path 10 and the flow of the heat medium toward the other side in the first flow path 10 are canceled. Thus, the stop state in which the flow of the heat medium in the first flow path 10 is stopped and the flow state in which the heat medium flows in the first flow path 10 are switched. That is, by adjusting the relationship between the flow rate of the water pump 21 and the flow rate of the water pump 31, it is possible to easily switch the flow state of the heat medium in the first flow path 10.

In the above embodiment, the flow rate of the water pump 21 and the water pump 31 is adjusted to switch the circulation state of the heat medium in the first flow path 10, but the present disclosure is not limited thereto. The circulation state of the heat medium in the first flow path 10 may be switched by adjusting the flow rate of only one of the water pump 21 and the water pump 31.

In the above embodiment, an example in which the heat source for raising the temperature of the heat medium is the unit circuit 22 has been described, but the present disclosure is not limited thereto. The heat source for raising the temperature of the heat medium may be other than the unit circuit 22 (for example, an electric heater). The heat source for cooling the heat medium may be other than the chiller device 33 (for example, a radiator).

The embodiment disclosed herein should be considered as illustrative and not restrictive in all respects. The scope of the present disclosure is shown by the claims, rather than the above embodiments, and is intended to include all modifications within the meaning and the scope equivalent to those of the claims.

What is claimed is:

1. A thermal management circuit through which a heat medium flows, the thermal management circuit comprising:
a battery;
a first flow path through which the heat medium to exchange heat with the battery flows;
a first flow rate adjusting unit configured to adjust a flow rate of the heat medium that flows in a first direction in the first flow path; and
a second flow rate adjusting unit configured to adjust a flow rate of the heat medium that flows in a second direction opposite to the first direction in the first flow path, wherein
at least one of the first flow rate adjusting unit and the second flow rate adjusting unit is configured to adjust the flow rate of the heat medium to switch:
a flowing state in which the heat medium flows through the first flow path; and
a stopped state in which a flow of the heat medium in the first flow path is stopped by canceling out a flow of the heat medium in the first direction in the first flow path and a flow of the heat medium in the second direction in the first flow path.

2. The thermal management circuit according to claim 1, further comprising:
a first heat source;
a second heat source;
a second flow path that is connected to one end of the first flow path and in which the heat medium exchanges heat with the first heat source; and
a third flow path that is connected to the other end of the first flow path and in which the heat medium exchanges heat with the second heat source, wherein
the first heat source is configured to raise a temperature of the heat medium by supplying heat to the heat medium,
the second heat source is configured to cool the heat medium by being supplied with heat from the heat medium,
a temperature raising circuit in which a temperature of the battery is raised is defined when the heat medium from the second flow path flows through the first flow path and a flow of the heat medium from the third flow path through the first flow path is restricted,
a cooling circuit in which the battery is cooled is defined when the heat medium from the third flow path flows through the first flow path and a flow of the heat medium from the second flow path through the first flow path is restricted, and
a flow stop circuit in which the flow of the heat medium in the first flow path is stopped is defined when the flow of the heat medium from the second flow path and the flow of the heat medium from the third flow path are canceled out in the first flow path.

3. The thermal management circuit according to claim 2, wherein:
the second heat source is a chiller device; and
the thermal management circuit further includes
a refrigeration cycle connected to the chiller device and including a compressor;
a first heat exchanger provided on a downstream side of a portion where the first heat source and the heat medium exchange heat in the second flow path,
a high temperature circuit that is connected to the first heat exchanger and in which an electric heater is disposed, and
a second heat exchanger configured to exchange heat with a heat medium in the refrigeration cycle and a heat medium in the high temperature circuit.

4. The thermal management circuit according to claim 3, further comprising a first radiator connected in parallel to each of the second flow path and the third flow path, wherein
the high temperature circuit includes a heater core and a second radiator,
when the temperature raising circuit is defined, waste heat of each of the first heat source and the battery is used for heating through the heater core or dissipated to outside air through the second radiator, and
when the cooling circuit is defined, the heat medium cooled by the first radiator is further cooled by the chiller device.

5. The thermal management circuit according to claim 2, further comprising:
a first flow path switching valve provided on a downstream side of a first portion where the first heat source and the heat medium exchange heat in the second flow path, and configured to switch flow paths of the heat medium;
a second flow path switching valve provided on an upstream side of a second portion where the second heat source and the heat medium exchange heat in the third flow path, and configured to switch the flow paths of the heat medium;
a flow valve provided opposite to the second flow path switching valve with respect to the second portion of the third flow path, and configured to control the flow of the heat medium;
a first connecting flow path connecting a first connecting portion and the second flow path switching valve, the first connecting portion being a portion of the first flow path between the first flow path switching valve and a third portion where the battery and the heat medium exchange heat; and
a second connecting flow path connecting a second connecting portion and the first flow path switching valve, the second connecting portion being a portion of the third flow path between the second portion and the second flow path switching valve, wherein
the first flow path connects the first flow path switching valve and a third connecting portion, the third connecting portion being a portion of the third flow path between the second portion and the flow valve.

6. The thermal management circuit according to claim 1, wherein when outputs of the first flow rate adjusting unit and the second flow rate adjusting unit are increased or reduced in a predetermined cycle, an interface between the heat media that are mutually cancelled out reciprocates in a region corresponding to the battery in the first flow path.
